(19) United States
(12) Patent Application Publication
(10) Pub. No.: US 2011/0221762 A1
(43) Pub. Date: Sep. 15, 2011

(54) CONTENT-ADAPTIVE OVERDRIVE SYSTEM AND METHOD FOR A DISPLAY PANEL

(75) Inventors: Chao-Chung Cheng, Taipei (TW); Yung-Lin Huang, Taipei (TW); Sheng-Chun Niu, Tainan (TW); Ying-Ru Chen, Tainan (TW)

(73) Assignees: NATIONAL TAIWAN UNIVERSITY, Taipei (TW); HIMAX MEDIA SOLUTIONS, INC., Tainan (TW); HIMAX TECHNOLOGIES LIMITED, Tainan (TW)

(21) Appl. No.: 12/724,003

(22) Filed: Mar. 15, 2010

(51) Int. Cl. G06T 1/00; G09G 5/00

(52) U.S. Cl. 345/611; 345/522

(57) ABSTRACT

A content-adaptive overdrive system and method, for a display panel, include a frame difference device and an overdrive device. The frame difference device generates a frame difference map according to a current frame and a previous frame. The frame difference map includes a number of flags respectively indicating similarity between corresponding pixels or blocks of the current frame and the previous frame. The overdrive device adaptively performs an overdrive function based on the frame difference map, the current frame, the previous frame and an overdrive lookup table, hence resulting in an overdrived frame.

### BACKGROUND OF THE INVENTION

1. Field of the Invention

The present invention generally relates to digital image display, and more particularly to content-adaptive overdriving of a digital display panel.

2. Description of Related Art

Moving pictures usually suffer from motion blur in a digital image display such as a liquid crystal display (LCD) when the liquid molecules cannot respond quickly enough to image changes. In order to resolve this issue, frame rate up conversion (FRUC) is commonly used in a digital image display to generate one or more intermediate frames between two original adjacent frames, such that the display frame rate may be increased, for example, from 60 Hz to 120 Hz or 240 Hz.

An overdrive technique is commonly used independently of or in combination with the FRUC to speed up the response time and thus combat motion blur of the LCD panel. In overdriving the LCD panel, an overdriving voltage greater than a target voltage is applied for increasing image data, and an undershooting voltage less than a target voltage is applied for decreasing image data. The overdriving voltage and the undershooting voltage are usually pre-stored in an overdrive lookup table (OD LUT). In the operation, the overdriving/undershooting voltage for each pixel may be located in the OD LUT according to the target value of a current frame and the beginning value of a previous frame. The overdrive lookup is performed throughout (i.e., for) all pixels of the current frame and the previous frame. Accordingly, a great amount of bandwidth and large process latency are required to retrieve/process the pixels of the current frame and the previous frame.

For the reason that conventional overdrive techniques cannot effectively solve the motion blur issue, a need exists to propose a novel overdrive scheme for reducing bandwidth and latency while improving on motion blur.

### SUMMARY OF THE INVENTION

In view of the foregoing, it is an object of the embodiments of the present invention to provide a system and a method for adaptively overdriving a display panel, such that the system bandwidth may be substantially reduced while still preserving an effectiveness of the overdrive and a quality of the image display.

According to one embodiment, a frame difference device generates a frame difference map according to a current frame and a previous frame, wherein the frame difference map includes a number of flags respectively indicating similarity between corresponding pixels or blocks of the current frame and the previous frame. An overdrive device is then configured to adaptively perform an overdrive function based on the frame difference map, the current frame, the previous frame and an overdrive lookup table, thereby resulting in an overdrived frame. In one embodiment, a smoothing filter is further provided to smooth the overdrived frame thereby facilitating smoothing of boundary transitions between the overdrived pixels and unchanged pixels.

### BRIEF DESCRIPTION OF THE DRAWINGS

FIG. 1 is a block diagram that illustrates a content-adaptive overdrive system for a display panel according to one embodiment of the present invention;

FIG. 2 is a flow diagram illustrating a content-adaptive overdrive method according to one embodiment of the present invention; and

FIG. 3 shows an exemplary overdrive lookup table (OD LUT).

### DETAILED DESCRIPTION OF THE INVENTION

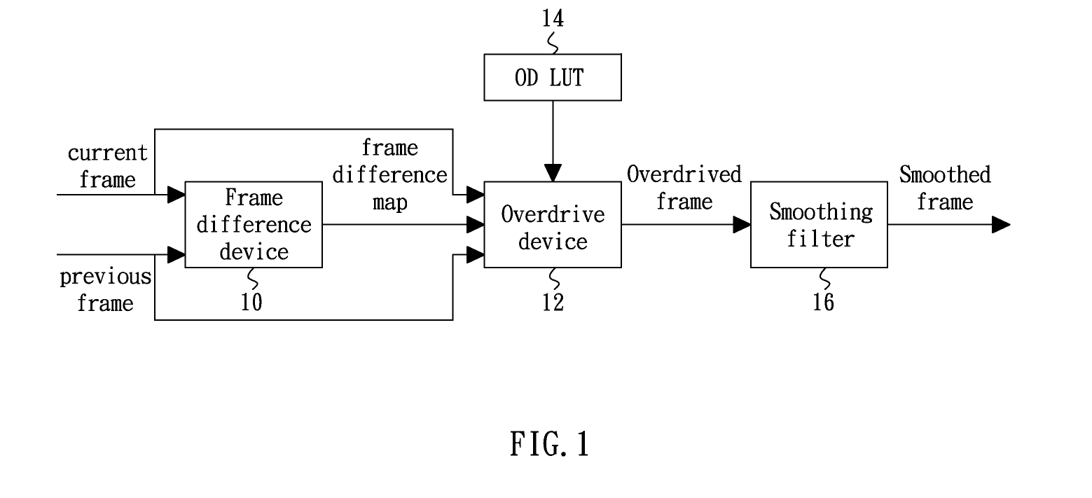

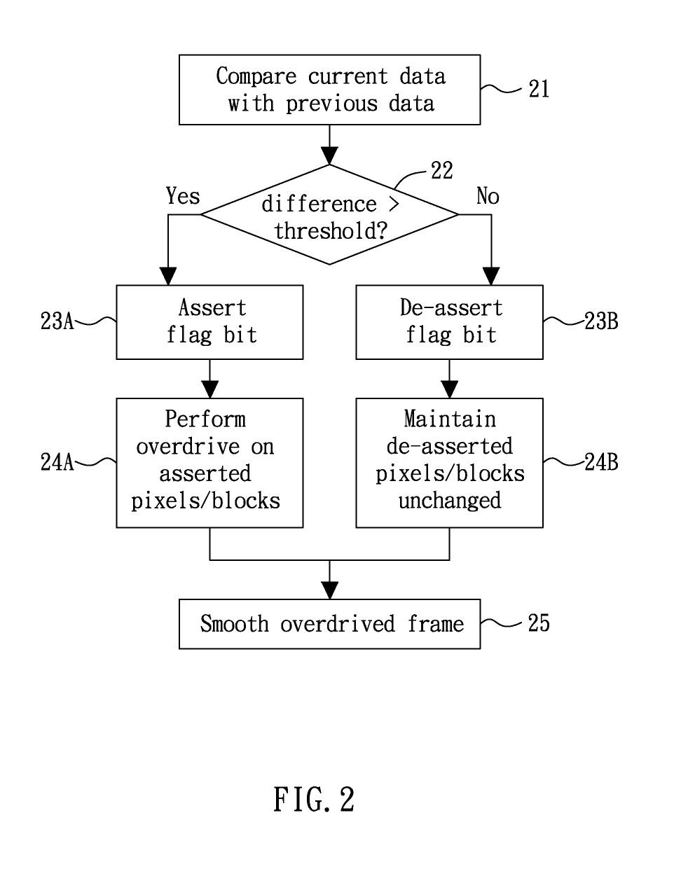

Referring more particularly to the drawings, FIG. 1 is a block diagram that illustrates a content-adaptive overdrive system for a display panel according to one embodiment of the present invention. FIG. 2 provides a flow diagram to illustrate a content-adaptive overdrive method according to the embodiment of the present invention. The overdrive system and method may be embedded, for example, in a timing controller (Tcon), and the display panel may be, but is not limited to, a liquid crystal display (LCD) panel.

In the embodiment, a frame difference device 10 receives a previous frame and a current frame in order to obtain a frame difference map. Specifically, with respect to each pixel or each block, image data of the current frame and image data of the previous frame are compared at step 21. If at step 22 the resultant difference is greater than a predetermined threshold, a flag (such as a flag bit) corresponding to the pixel or the block is then asserted at step 23A; otherwise the flag is de-asserted at step 23B.

In one exemplary embodiment, each pixel corresponds to a flag bit of the frame difference map. That is, the current frame is compared to the previous frame pixel-by-pixel. The resultant difference, in the embodiment, is the absolute value of the result of the image data of the previous frame subtracted from the image data of the current frame. A flag bit “1” indicates that, at the corresponding pixel, the current image data is substantially different from the previous image data (i.e., the difference is greater than the threshold), and the corresponding pixel thus needs overdrive in order to compensate for or overcome the motion blur issue. On the other hand, a flag bit “0” indicates that, at the corresponding pixel, the current image data is similar to or the same as the previous image data, and the corresponding pixel does not need overdrive, therefore effectively decreasing bandwidth usage.

In another exemplary embodiment, each block corresponds to a flag bit of the frame difference map. That is, the current frame is compared to the previous frame block-by-block. Each block may consist of a pixels array, such as 4×4 pixels array. A sum of absolute differences (SAD) may, for example, be used as a metric for determining block similarity, while other metrics such as a sum of squared differences (SSD) may be adapted instead. The resultant difference, in the embodiment, is the SAD between the previous frame and the current frame. When the SAD is greater than a threshold, the corresponding flag bit of the frame difference map is asserted; otherwise the flag bit is de-asserted.

In a further exemplary embodiment, a (block-based) motion vector map between the current frame and the previous frame is referenced for determining the frame difference map. That is, a motion vector of the motion vector map corresponds to a flag of the frame difference map one-by-one, and each of the flags is determined based on the corresponding motion vector. When the motion vector of the current block, for example, is substantially close to (0, 0) or the absolute of the motion vector is small enough (i.e., the absolute of the motion vector does not exceed a threshold), the corresponding flag bit of the frame difference map is asserted; otherwise the flag bit is de-asserted. It is noted that the motion vectors or the pixel difference may be retrieved from an image processor in the display panel without exercising extra effort or expending additional resources.

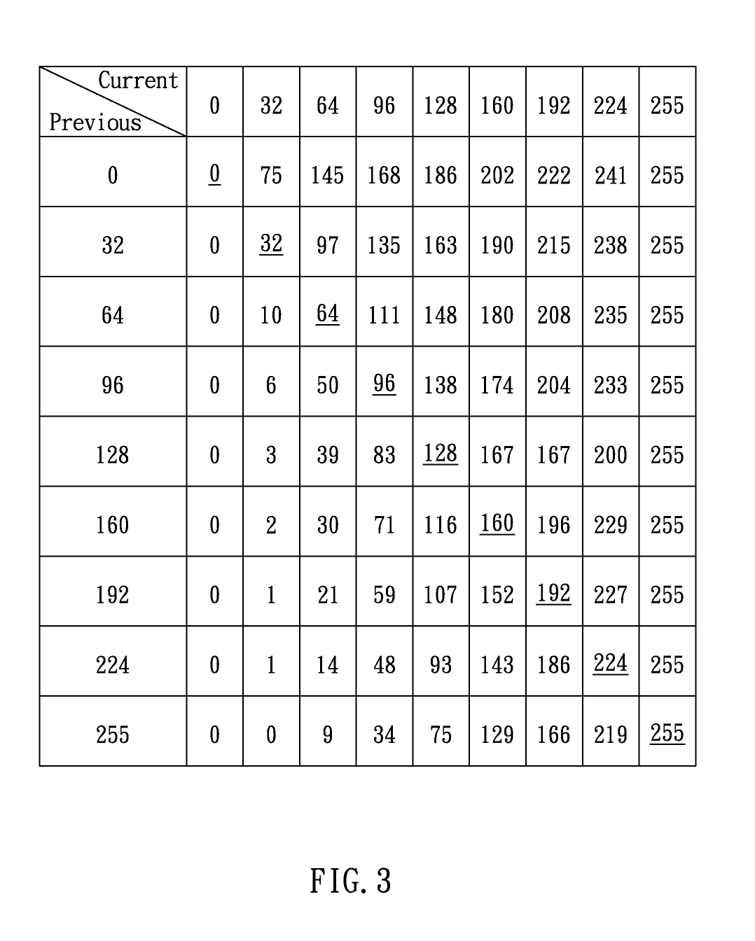

Subsequently, an overdrive device 12 performs an overdrive function based on the (pixel-based or block-based) frame difference map, the current frame, the previous frame and an overdrive lookup table. Specifically, regarding the pixel-based overdrive, the overdrive device 12 performs overdrive on the pixels with asserted flags at step 24A, while maintaining other pixels unchanged as indicated by block 24B. Similarly, regarding the block-based overdrive, the overdrive device 12 performs overdrive on the blocks with asserted flags at step 24A, while maintaining other blocks unchanged per block 24B. It is noted that, as the previous image data with de-asserted flags need not be retrieved, substantive bandwidth may be saved. The overdrive device 12 may perform overdrive according to an overdrive lookup table (OD LUT) 14 as exemplified in FIG. 3. For example, if the previous image data is “32” and the (target) current image data is “64,” a resultant image data “97” is outputted as “overdrived” image data. Accordingly, the overdrived image data and the unchanged image data together form an overdrived (current) frame. It is noted that the threshold value (block 10/step 22) or the overdrive LUT (block 14) may be dynamically adjusted, for example, by feeding back the frame difference map or the overdrived frame to an image processor (not shown).

In the embodiment, the overdrived frame may be further processed by a smoothing filter 16 in order to smooth the overdrived frame (step 25), such as, particularly, at boundary transitions between the overdrived image data and the unchanged image data. The smoothing filter 16 may be a global filter (e.g., linearly smoothing filter) that performs smoothing on the entire overdrived frame, or may be a local filter (e.g., piecewise smoothing filter) that performs smoothing on a selected region or regions. The smoothing filter may, for example, be a low pass filter that attenuates high frequency components such as the discontinuous transitions between overdrived image data and unchanged image data. In the embodiment, a low pass spatial filter (commonly known as an averaging filter) such as a filter mask is used to replace image data of a pixel by the average (with respective weightings) of the pixels contained in the neighborhood of the filter mask, therefore reducing sharp transitions between the overdrived image data and the unchanged image data.

According to the embodiments illustrated above, overdrive may be adaptively performed on an image frame. The overdrive is specifically performed on regions that are apt to be perceivable by the eyes, such as those regions substantially distinct from the previous frame, while skipping over other regions that are not well perceivable. As a result, the effectiveness of the overdrive may be well preserved with a greatly reduced bandwidth usage and process latency whereby image quality is not sacrificed.

Although specific embodiments have been illustrated and described, it will be appreciated by those skilled in the art that various modifications may be made without departing from the scope of the present invention, which is intended to be limited solely by the appended claims.

What is claimed is:

1. A content-adaptive overdrive system for a display panel, comprising:
a frame difference device constructed to generate a frame difference map according to a current frame and a previous frame, wherein the frame difference map includes a plurality of flags respectively indicating similarity between corresponding pixels or blocks of the current frame and the previous frame; and
an overdrive device configured to adaptively perform overdrive based on the frame difference map, the current frame, the previous frame and an overdrive lookup table, thereby resulting in an overdrived frame.

2. The system of claim 1, wherein according to the construction the frame difference device correspondingly compares image data of the current frame with image data of the previous frame with respect to each pixel or each block, thereby resulting in a difference between the image data of the current frame and the image data of the previous frame for generating the flag.

3. The system of claim 2, wherein the frame difference device is further constructed to assert the flag corresponding to the pixel or the block at which the difference is greater than a threshold, and otherwise to de-assert the flag.

4. The system of claim 3, wherein each of the flags corresponds to a pixel of the current frame and the previous frame, and the difference is an absolute value of a result of subtraction of the image data of the previous frame and the image data of the current frame.

5. The system of claim 3, wherein each of the flags corresponds to a block of the current frame and the previous frame, and the difference is the sum of absolute differences (SAD) between the previous and the current frame.

6. The system of claim 3, wherein the overdrive device is configured to perform overdrive on pixels with corresponding asserted flags while maintaining pixels with corresponding de-asserted flags unchanged.

7. The system of claim 6, further comprising a smoothing filter configured to smooth the overdrived frame for smoother boundary transitions between the overdrived pixels and the unchanged pixels.

8. The system of claim 1, wherein each of the flags corresponding to a block of the current frame and the previous frame is determined based on each motion vector of a motion vector map between the current frame and the previous frame.

9. A content-adaptive overdrive method for a display panel, comprising:
generating a frame difference map according to a current frame and a previous frame, wherein the frame difference map includes a plurality of flags respectively indicating similarity between corresponding pixels or blocks of the current frame and the previous frame; and
adaptively performing overdrive based on the frame difference map, the current frame, the previous frame and an overdrive lookup table, thereby resulting in an overdrived frame.

10. The method of claim 9, wherein the step of generating the frame difference map comprises:
comparing image data of the current frame with image data of the previous frame with respect to each pixel or each block, thereby resulting in a difference between the image data of the current frame and the image data of the previous frame for generating the flag.

11. The method of claim 10, wherein the step of generating the frame difference map comprises:
asserting the flag corresponding to the pixel or the block at which the difference is greater than a threshold, and otherwise de-asserting the flag.

12. The method of claim 11, wherein each of the flags corresponds to a pixel of the current frame and the previous frame, and the difference is an absolute value of a result of subtraction of the image data of the previous frame and the image data of the current frame.

13. The method of claim 11, wherein each of the flags corresponds to a block of the current frame and the previous frame, and the difference is the sum of absolute differences (SAD) between the previous and the current frame.

14. The method of claim 11, wherein overdrive is adaptively performed on pixels with corresponding asserted flags, and pixels with corresponding de-asserted flags are maintained unchanged.

15. The method of claim 14, further comprising a step of:
smoothing the overdrived frame in order to smooth boundary transitions between the overdrived pixels and the unchanged pixels.

16. The method of claim 9, wherein each of the flags corresponding to a block of the current frame and the previous frame is determined based on each motion vector of a motion vector map between the current frame and the previous frame.
